(19) United States
(12) Patent Application Publication
(10) Pub. No.: US 2020/0137035 A1
(43) Pub. Date: Apr. 30, 2020

(54) Secure, On-Demand Generation of Web Content

(71) Applicant: Stash America LLC, Las Vegas, NV (US)

(72) Inventors: Christopher Evans, Las Vegas, NV (US); Janine Darling, Las Vegas, NV (US); Paul Twomey, Las Vegas, NV (US)

(21) Appl. No.: 16/722,036

(22) Filed: Dec. 20, 2019

Related U.S. Application Data
(63) Continuation-in-part of application No. 15/857,797, filed on Dec. 29, 2017.

(51) Int. Cl. H04L 29/06

(52) U.S. Cl. CPC H04L 63/067; H04L 63/0428

(57) ABSTRACT

Traditional web servers store content and make it available on a continuous basis, significantly increasing the attack surface for hackers looking to compromise sensitive content. The technology, system, and methods proposed in this document seek to address this significant vector by transforming structured and unstructured web content into a single-file format, storing it in a data-centric secure data storage system, and then generating the content, on-demand, when requested by the web server. The proposed solution includes methods for storing and generating the content on demand, processing the content securely, and ensuring its integrity.

### CLAIM TO PRIORITY

This application claims under 35 U.S.C. § 120, the benefit as a Continuation-in-Part of the patent application Ser. No. 15/857,797, filed Dec. 29, 2017, titled “Data-Centric Secure Data Technology, Archiving, and Storage System” which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Attacks targeting content hosted on web servers are the number one type of data compromise attacks currently seen. Content such as pictures, videos, usernames, passwords, profile information, documents, and the like, are continuously at risk when stored on a traditional web server that's accessible 24 hours a day, 7 days a week. The underlying problem is that web content is always available, and only by generating that data, on-demand, only when its needed to fulfill a request, can the risk from this content accessibility be mitigated.

Other web security solutions seek to protect the web server itself from attacks, or detect and mitigate attacks against the web server. These solutions have proven to be ineffective as the number and scope of data breaches from publicly available sites continues to grow.

Data security and data integrity are integral to network and computer security. Although numerous systems have been created to address these factors, data security breaches continue to occur.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of the system architecture reflecting the data-centric, on-demand secure web content gateway, and the two components with which it interacts, a traditional end-user web server, and a data-centric secure data storage system consistent with certain embodiments of the present invention.

FIG. 2 is a process flow chart depicting how data from a traditional web server is transformed into a representation that can be generated on-demand and stored in a data-centric secure data storage system consistent with certain embodiments of the present invention.

FIG. 3 is a process flow chart depicting how data is retrieved, on-demand, re-generated or transformed back into its original format, and transmitted to the end-user web server to fulfill a data request consistent with certain embodiments of the present invention.

FIG. 4 presents a file format of the structured data transformed by the data-centric on-demand secure web content gateway consistent with certain embodiments of the present invention.

FIG. 5 presents a file format structure of the unstructured data transformed by the data-centric on-demand secure web content gateway consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “web content” refers to any information in text, audio, multimedia, visual representation, or any other information formatted for search and retrieval through the operation of a web browser.

Reference throughout this document to “data security” refers to providing for the data-centric protection, secure access, security, integrity and storage of data committed to computer networks in any electronic storage form or format.

Reference throughout this document to “supplemental information” includes, but is not limited to, an encryption key, content type identifier, content identifier, data owner identifier, and the validation rules which must be satisfied for the content to be retrieved.

Reference throughout this document to “validation rules” refers to validation rules that may contain a plurality of information including unique identifiers, date/time requirements, source IP address, geographic location, operating system fingerprint, and other similar identifying characteristics, one or more of which may be “negated” rules. A negated rule is a rule where lack of a characteristic being present fulfills the rule.

In an embodiment of the invention, a system and methods for providing on-demand access to web content that is stored within a data-centric secure data storage system is proposed. This invention is an extension to a previous invention covered under patent application, and relies on that inventions system and methods for securely storing data. The proposed system and method allow data stored in the previous invention to be generated on-demand in response to a request from an end-user web server. The proposed system and method also allow structured and un-structured data to be stored in the system and retrieved, on-demand, through use of a unique, one-to-one request/fulfillment arrangement.

In an embodiment, the system, runs on a web server associated with an end user, and on another server associated with the data transformation functions and gateway connectivity with the data-centric secure data storage system. The end-user web server may be implemented on any computing device such as a laptop form factor device, desktop form factor device, a network computer form factor device, a server form factor device, or any similar device having network communication capability either through wired or wireless connections, and with the ability to serve or deliver World Wide Web (www) based content to users. The data transformation and gateway server may be implemented on any computing device such as a laptop form factor device, desktop form factor device, a network computer form factor device, a server form factor device, or any similar device having network communication capability either through wired or wireless connections.

In an embodiment, data from an end-user web server, either in structured or unstructured form, is identified to be secured by the system. Each individual file, if unstructured data, or record, if structured data, is assigned a unique identifier representing the data, and is assigned another, separate unique identifier representing the data owner. This data, along with the unique content identifier, and the unique owner identifier, is securely sent from a Data-Centric secure electronic data storage system to the gateway server via a one-time use encryption key.

In an embodiment, the data is received from the end-user web server and decrypted using the one-time use encryption key. This data is then transformed into a single file representation of the original data regardless of its original structure and content. This single file representation contains the original data content (supplemental information) along with an encryption key, content type identifier, content identifier, data owner identifier, and the validation rules which must be satisfied for the content to be retrieved. This file is then transmitted to the data-centric secure electronic data storage system for storage.

In an embodiment, methods are provided on the end-user web server, to facilitate identification, transmission, transformation, and storage of single files, multiple files, and directories of files. The system also provides methods for parsing structured data, stored in a database, and facilitating the identification, transmission, transformation, and storage of data stored in tables in a database management system.

In an embodiment, the system receives a request from an end-user web server for data and fulfills the request, generating the data on-demand. Upon receiving a request from the end user web server, the system generates a one-time use password, retrieves the content identifier and the data owner identifier, and transmits this information securely to the gateway server secured with the one-time use password. The system generates the original content by retrieving the file from the data-centric secure data storage system that matches the request, and transforming the file back into its original format from the single file representation of the original data along with identifying information and validation rules that were stored in the transformed single file representation.

In an embodiment, the system parses the validation rules and compares them to the request to ensure the request is valid. The validation rules contain a plurality of information including unique identifiers, date/time requirements, source IP address, geographic location, operating system fingerprint, and other similar identifying characteristics, one or more of which may be “negated” rules where lack of a characteristic being present fulfills the rule. Based on the provided rules, the system checks each rule and if all rules pass, the system returns the data in its original format to the requesting web server.

In an embodiment, the original data content is transformed into a representation containing the original data and supplemental information as previously outlined. The content of unstructured data files are stored in the representation without alteration with the supplemental information pre-pended to the data content. For structured data, that which is stored in a database, a plurality of records may be stored in text-encoded format along with supplemental information on the characteristics of the records, including number of records, record structure and data types, field names, and source table name. The transformed files are given a unique content identifier as a file name, comprised of the content identifier, owner identifier, file name, content type, and date/time stamp the transformed file was created.

In an embodiment, the system provides end-to-end encryption of data transmitted between the end-user web server and the secure web content gateway server using one-time passwords. The implementation of this uses public domain Time-Based One Time Password (TOTP) algorithms for password generation and validation. In another embodiment, the system compresses data transmitted between the end-user web server and the gateway server to reduce transmission time and bandwidth requirements. This implementation uses public domain ZLib based compression techniques. In another embodiment, the system ensures integrity of the web content transmitted from end-user web server to gateway server, and vice versa, by calculating and comparing a one-way cryptographic hash of the content on both the sending and receiving systems. In a prototype implementation, this is performed use public domain SHA1 hash algorithms.

In an embodiment, the system, running on a device associated with an end user, provides representations of files for the user to interact with as a plurality of protected locations. The end-user device may be implemented as a mobile device such as a cell, mobile, or smartphone, a tablet form factor device, a laptop form factor device, a desktop form factor device, a network computer form factor device, or any similar end-user client device having network communication capability either through wired or wireless connections. The end-user device may also be implemented as a server form factor device.

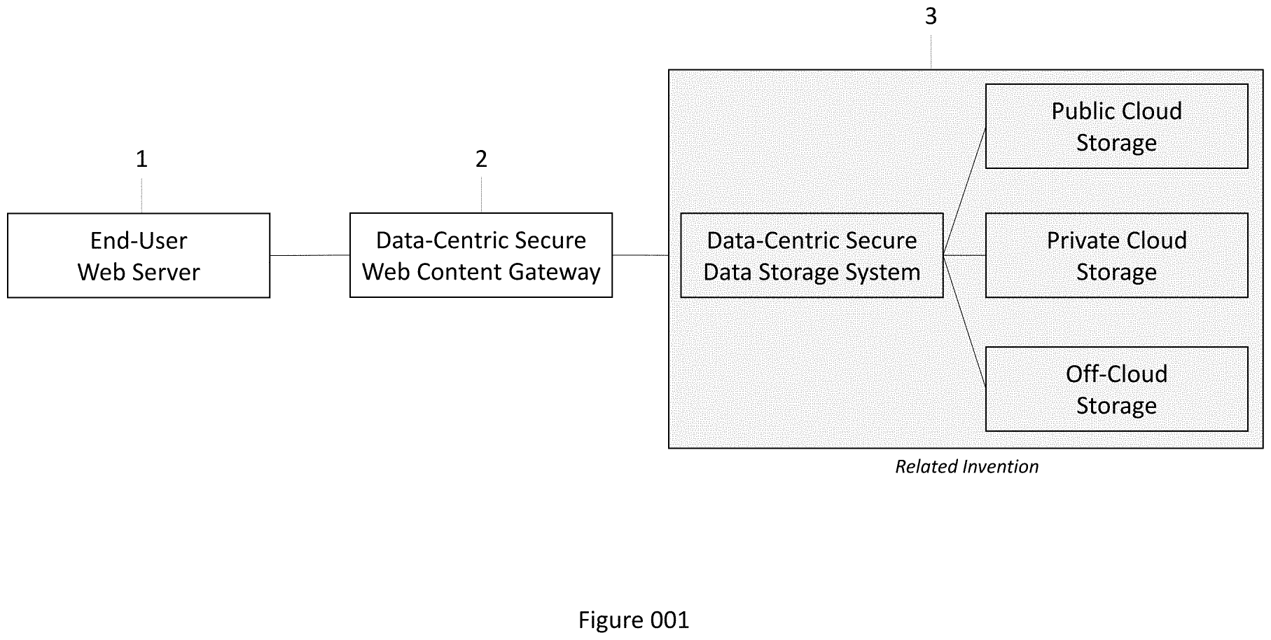

Turning now to FIG. 1, this figure presents a view of the system architecture components consistent with certain embodiments of the present invention. In an exemplary embodiment, an end-user web server 1 stores web content through the data-centric secure web content gateway 2 to the data-centric secure data storage system 3. When content for a web server client is needed based upon a request for content from one or more users, the end-user web server requests the content from the secure web content gateway 2. The data-centric secure web content gateway 2 operates as a secure intermediary for data content generation and retrieval. Upon receiving a content request, the data-centric secure web content gateway 2 generates the data from the data-centric secure data storage system 3. The data-centric secure web content gateway 2 provides security of the data between it and the end-user web server 1, and transformation of the data to and from an on-demand file format structure.

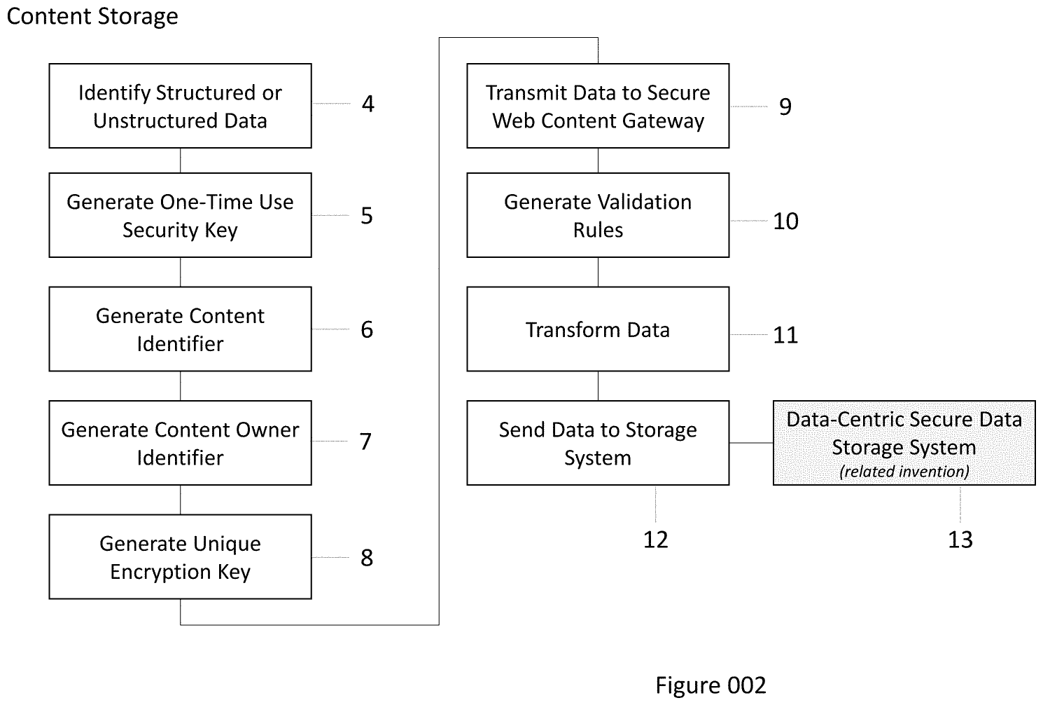

Turning now to FIG. 2, this figure depicts the steps the invention follows when storing web content on behalf of an end-user web server. In an exemplary embodiment, the user identifies structured or unstructured data content 4 to be transformed and secured by the system. The system may generate a one-time security key 5 for securing the data transmission to the data-centric secure web content gateway server 2, as well as a globally unique content identifier 6, a globally unique content owner identifier 7, and a unique encryption key for the content itself 8. The system encrypts all user identified structured or unstructured data content utilizing the one-time security key. The system then transmits this data 9, encrypted with the one-time use security key to the gateway server 2. The gateway server 2 generates a set of validation rules 10 governing the use of the content. Upon completion of the set of validation rules, the system transforms the content and supplemental information 11 to create a structured or unstructured data transformed file structure based at least in part on the user identification for the data being transformed. The gateway server 2 then sends this information 12 to the data-centric secure data storage system 13.

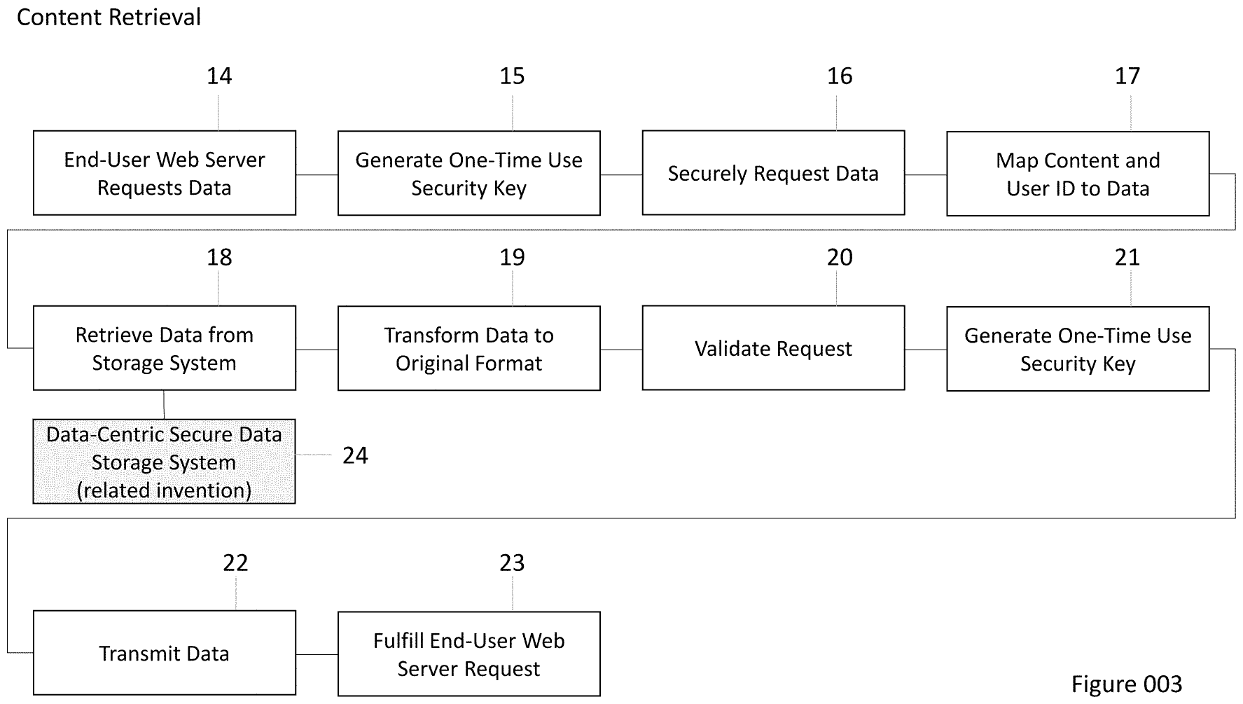

Turning now to FIG. 3, is a process flow chart depicting how data is retrieved, on-demand, re-generated or transformed back into its original format, and transmitted to the end-user web server to fulfill a data request from a user consistent with certain embodiments of the present invention. The process depicts the steps the invention follows when retrieving web content, on demand, from the data-centric secure data storage system 3. When an end-user web server requests data 14, the system generates a one-time security key 15 to encrypt the request and securely transmits the request 16 to the gateway server 2. The gateway server 2 then identifies the original content 17 by mapping the unique identifiers provided in the request to the content that includes the matching unique identifiers. The gateway server 2 then retrieves the identified web content 18, stored in its transformed format, from the data-centric secure data storage system 3, and transforms it back into the original user identified content and any supplemental information 19. The server parses the validation rules stored in the supplemental information to validate the request 20. If the validation rules all pass, the content request is validated and the server generates a one-time use security key 21. The one-time use security key is utilized to encrypt the transmission of the identified and requested web content data back to the end-user web server 22. The system then fulfills the end-user web server's request with the web content 23 retrieved from the data-centric secure data storage system 3.

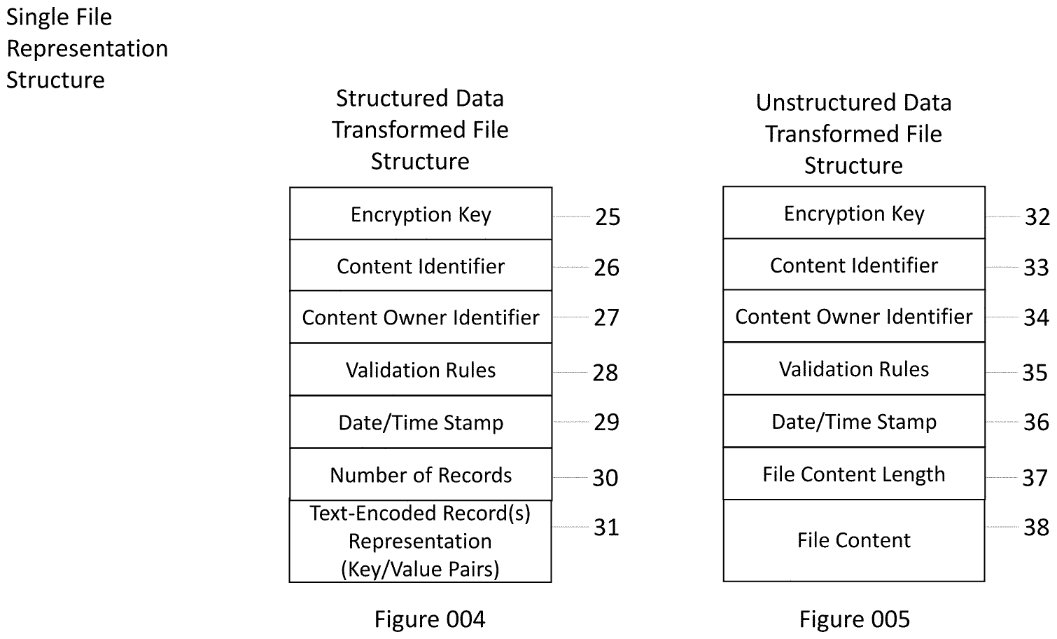

Turning now to FIG. 4, presents a file format of the structured data transformed by the data-centric on-demand secure web content gateway consistent with certain embodiments of the present invention. The figure presents an exemplary embodiment of a file format used to store the transformed structured data and supplemental information. The supplemental information of encryption key 25, globally unique content identifier 26, globally unique content owner identifier 27, validation rules 28, date/time stamp 29, and number of records 30, are pre-pended to the plurality of data records that have been text-encoded into key/value pairs and Base-64 encoded 31 for storage.

Turning now to FIG. 5, presents a file format structure of the unstructured data transformed by the data-centric on-demand secure web content gateway consistent with certain embodiments of the present invention. The figure presents an exemplary embodiment of a file format used to store the transformed unstructured data and supplemental information. The supplemental information of encryption key 32, globally unique content identifier 33, globally unique content owner identifier 34, validation rules 35, date/time stamp 36, and file content length in bytes 37, are pre-pended to Base-64 encoded file content 38 for storage.

While certain illustrative embodiments have been described, it is evident that many alternatives, modifications, permutations and variations will become apparent to those skilled in the art in light of the foregoing description.

We claim:

1. A system for secure data storage and retrieval, comprising:
a data processor having network connections to a secure web content gateway server;
said data processor transmitting user identified content to said secure web content gateway server;
said secure web content gateway server transforming user identified content and a set of supplemental information including one or more validation rules into a transformed data set;
said secure web content gateway server encrypting said transformed data set and transmitting the encrypted transformed data set to a secure data storage system for storage in an electronic data file;
said data processor transmitting a user request for retrieval of user identified content to the secure web content gateway server;
said secure web content gateway server retrieving an encrypted transformed data set upon validation that said encrypted transformed data set contains at least said user identified content;
said secure web content gateway server decrypting and transforming said encrypted transformed data set to produce said user identified content;
said secure web content gateway server generating a security key, encrypting said user identified content with the generated security key, and
transmitting said encrypted user identified content to the data processor and reported to the user.

2. The system of claim 1, where the transforming user identified content comprises changing the original format of structured and/or unstructured data into a single file representation of the original data regardless of its original structure and content.

3. The system of claim 1, where the supplemental information comprises at least an encryption key, content type identifier, content identifier, data owner identifier, and the validation rules which must be satisfied for the content to be retrieved.

4. The system of claim 3, where the content identifier further comprises a file name, comprised of the content identifier, owner identifier, file name, content type, and date/time stamp the transformed file was created.

5. The system of claim 3, where the one or more validation rules contain a plurality of information including unique identifiers, date/time requirements, source IP address, geographic location, operating system fingerprint, and other similar identifying characteristics, one or more of which may be “negated” rules where lack of a characteristic being present fulfills the rule.

6. The system of claim 1, where the security key comprises a one-time use security key generated just prior to use.

7. The system of claim 1, where the retrieved and decrypted transformed data set is returned to the original format and data structure.

8. A method for secure data storage and retrieval, comprising:
a data processor connecting to a secure web content gateway server;
transmitting user identified content to said secure web content gateway server;
said secure web content gateway server transforming user identified content and a set of supplemental information including one or more validation rules into a transformed data set;
encrypting said transformed data set and transmitting the encrypted transformed data set to a secure data storage system for storage in an electronic data file;
said data processor transmitting a user request for retrieval of user identified content to the secure web content gateway server;
retrieving at said secure web content gateway server an encrypted transformed data set upon validation that said encrypted transformed data set contains at least said user identified content;
decrypting and transforming said encrypted transformed data set to produce said user identified content;
generating a security key, encrypting said user identified content with the generated security key, and
transmitting said encrypted user identified content to the data processor for access by the user.

9. The method of claim 8, where the transforming user identified content comprises changing the original format of structured and/or unstructured data into a single file representation of the original data regardless of its original structure and content.

10. The method of claim 8, where the supplemental information comprises at least an encryption key, content type identifier, content identifier, data owner identifier, and the validation rules which must be satisfied for the content to be retrieved.

11. The method of claim 10, where the content identifier further comprises a file name, comprised of the content identifier, owner identifier, file name, content type, and date/time stamp the transformed file was created.

12. The method of claim 10, where the one or more validation rules contain a plurality of information including unique identifiers, date/time requirements, source IP address, geographic location, operating system fingerprint, and other similar identifying characteristics, one or more of which may be “negated” rules where lack of a characteristic being present fulfills the rule.

13. The method of claim 8, where the security key comprises a one-time use security key generated just prior to use.

14. The method of claim 8, where the retrieved and decrypted transformed data set is returned to the original format and data structure.
